(19) United States
(12) Patent Application Publication
(10) Pub. No.: US 2005/0109127 A1
(43) Pub. Date: May 26, 2005

(54) Structural beam member

(76) Inventor: Roger A. Bullivant, Burton on Trent (GB)

Correspondence Address: SIDLEY AUSTIN BROWN & WOOD LLP, 717 NORTH HARWOOD, SUITE 3400, DALLAS, TX, 75201, US

(21) Appl. No.: 10/981,828

(22) Filed: Nov. 5, 2004

(30) Foreign Application Priority Data
Nov. 6, 2003 (GB) 0325894.4

(51) Int. Cl. G01L 1/22

(52) U.S. Cl. 73/862.474

(57) ABSTRACT

A beam member 20 is formed from two channel members 10 and a series of spaced diaphragm members 22. Alternative arrangements include diaphragm members external of the channel members, and the use of continuous diaphragm members. Spaces 33 between diaphragm members 22 may be filled with material such as a foam, an insulator or the like. Services such as pipes or wiring may be provided through apertures 47 formed in the diaphragm members 22.

This application is based on GB 0325894.4 filed with United Kingdom Patent Office on Nov. 6, 2003, the entire content of which is incorporated herein by reference.

### FIELD OF THE INVENTION

The present invention relates to structural beam members, particularly for use in building.

The present invention provides a structural beam member for use in building, comprising flexible spaced metal channel members and at least one diaphragm member, the diaphragm member spanning between the channel members and being connected therewith to form a composite load-bearing arrangement.

### SUMMARY OF THE INVENTION

Preferably the diaphragm member is of self-supporting synthetic foam. Preferably the presence of the diaphragm member provides stiffness to the beam member. The presence of the diaphragm member may provide racking resistance to the beam member.

Preferably the diaphragm member is received within the mouths of the channel members, to connect with the channel members. The channel mouths may have lips formed to engage material of the diaphragm member to retain the diaphragm member therein. The lips may cut into the diaphragm material as the beam member is constructed, thereafter to engage and retain the or each diaphragm member.

Alternatively, the or each diaphragm member may be located outside the channel members, in which case, they may form a substantially continuous diaphragm along the length of the beam member.

The diaphragm member or members may have recesses to receive portions of the channel walls and to engage therewith. The recesses may have nibs which initially deflect as the channel members are introduced, and returned to assist in retaining the channel members in the corresponding recess.

A plurality of diaphragm members are preferably provided, spaced apart along the beam member. Each diaphragm member preferably extends substantially perpendicular to the length of the beam. At least some of the diaphragm members may extend beyond the channel members, in the said perpendicular direction. At least some of the diaphragm members are provided with apertures for receiving services.

The space between diaphragm members may be filled with insulating material. The insulating material may be foamed concrete. The insulating material is preferably cast in situ.

Adhesive material may be used to connect the channel members and the diaphragm member or members.

An external surface of the beam member may be clad with a board member.

The invention also provides a building panel comprising a plurality of beam members as aforesaid, attached together.

Preferably the channel members of neighbouring beam members are attached to form the panel. The beam members may be attached together adhesively. The beam members may be attached together by means of one or more diaphragm members extending to engage channel members of more than one beam.

The invention also provides a wall arrangement comprising a trough member extending generally horizontally, a plurality of beam members as aforesaid, arranged substantially vertically and with their lower ends received in the trough member for support, a header member extending across the upper ends of the beam members and supported thereby.

The header member preferably provides a support for a floor panel in the region of the top of the beam members. The header member may provide support for a second plurality of beam members arranged substantially vertically, above the first plurality.

The invention also provides a floor construction comprising a plurality of structural beam members as defined above, at least one layer of thermal insulation supported by the beam members, and a layer of settable material supported by the thermal insulation.

Preferably, a plurality of thermal insulation layers are provided, which may have different properties. The thermal insulation layers may be polystyrene, and the different layers may have different densities.

A gas membrane is preferably incorporated within the floor construction.

The settable material is preferably a cementitious material, such as a screed.

### BRIEF DESCRIPTION OF THE DRAWINGS

Embodiments of the present invention will now be described in more detail, by way of example only, and with reference to the accompanying drawings, in which:

FIG. 1 is an end view of a channel section for use in the present invention;

FIG. 2 is a partial perspective view of a first embodiment of a beam member in accordance with the present invention;

FIGS. 3A, B and C are partial end views of the beam member of FIG. 2, illustrating steps in the construction of the beam member;

FIG. 4 is a perspective view of a diaphragm member for the first embodiment of the invention;

FIG. 5 is a diagrammatic representation of the manner of constructing the beam member of FIG. 2, viewed from the centre line of the beam being formed;

FIG. 6 is a partial end view of a diaphragm member for a second embodiment;

FIG. 7 is an end view of the second embodiment;

FIG. 8 is a perspective view of a first version of the second embodiment;

FIG. 9 is a perspective view of a second version of the second embodiment;

FIG. 10 illustrates the first embodiment in use as part of a wall or floor panel;

FIGS. 11 and 12 are section and elevation views, respectively, of a wall arrangement constructed from a plurality of beam members; and

FIG. 13 is a vertical section through a floor construction using beams of the type shown in FIG. 2.

### DETAILED DESCRIPTION

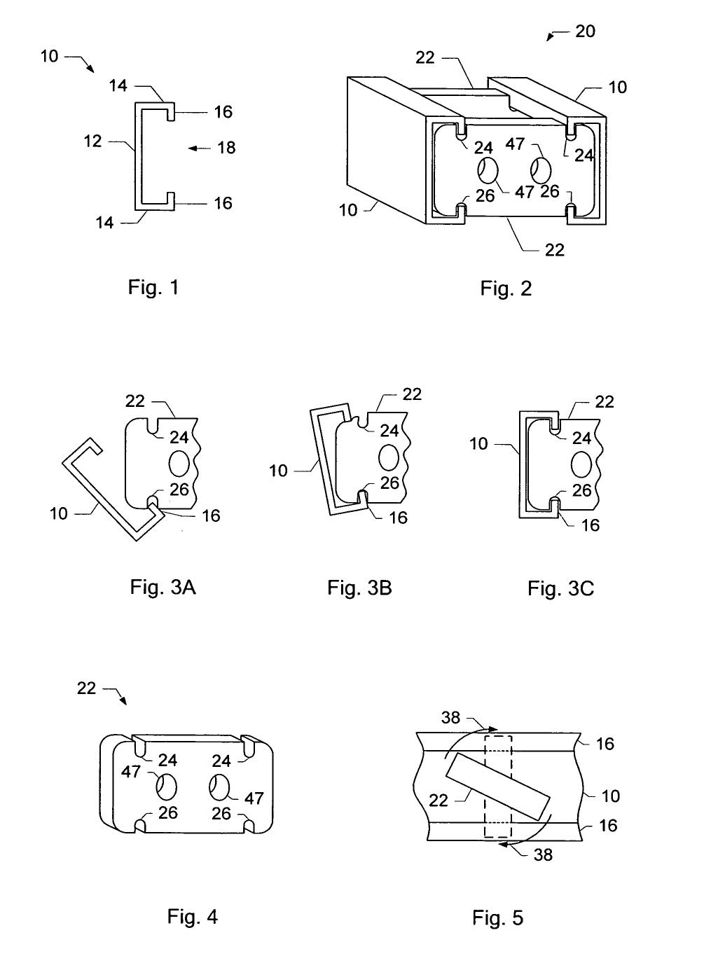

FIG. 1 illustrates a channel member 10 for use in forming beam members in accordance with the invention. The channel member 10 has a base 12, side walls 14 and lips 16, carried by the side walls 14 to define a mouth 18. The channel member is an elongate member having substantially constant section along its length. The member 10 is a flexible metal member. The member 10 may be formed from relatively thin steel (to provide flexibility), such as by rolling.

FIG. 2 shows two channel members 10 of the type shown in FIG. 1, incorporated into a structural beam member 20 in accordance with a first embodiment of the invention. The two members 10 are spaced apart with their mouths 18 facing each other. The mouths receive diaphragm members 22. In this example, the diaphragm members are formed from self-supporting synthetic foam sheet material, such as sheet polystyrene foam. Each member 22 spans between the channel members 10 and is connected with the members 10, as will be described, to form a composite load bearing arrangement. Two members 22 are illustrated. A much larger number of diaphragm members are likely to be used in practice.

Four recesses 24, 26 are provided around the periphery of each diaphragm member 22, for receiving the lips 16 of the members 10. These are illustrated in FIG. 4. By this means, the members 10 are secured to the members 22, which in turn maintain the spacing of the members 10. This results in an arrangement which has stiffness beyond the stiffness of the members 10, 22 alone. In addition, the diaphragm members 22 provide racking resistance between the members 10, that is, resistance to movement of one member 10 in the longitudinal direction, relative to the other.

The beam member of FIG. 2 can be constructed in the manner indicated in FIGS. 3A, B and C. Initially, one lip 16 (the lower lip, as illustrated) is positioned in the lower recess 26 of each member 22, with the member 10 leaning out, relative to the members 22, so that the upper lip is clear of the upper corners 28 of the members 22. The member 10 then pivots in, turning about the lower recesses 26, until the upper lip 16 engages the upper corners 28 (FIG. 3B). As the member 10 continues to turn, the upper corners 28 are deflected to allow the upper lip 16 to pass over the corners 28, into the upper recesses 24. At this point, the corners 28 snap back to their original position (FIG. 3C), leaving the lips 16 retained in the upper and lower recesses 24, 26.

Adhesive may be applied to the channel members 10 and the diaphragm members 22 prior to assembly.

A second member 10 is attached to the other edge of the member 22 in a similar manner.

This results in a beam member (FIG. 2) in which the diaphragms between the channels are internal of the channel members 10. Thus, the beam member has intermittent internal diaphragm arrangements. Spaces 33 exist between each neighbouring diaphragm members 22. These spaces 33 may be filled with an insulating material, such as a foamed concrete or foamed polystyrene, preferably cast in situ.

The diaphragm members 22 may alternatively be fitted to the members 10 in the manner illustrated in FIG. 5. Initially, each member 22 is offered to the channel members at an angle (bold lines in FIG. 5) so that the edges 22 can enter the mouths 18 of both channel members 10. The member 22 is then turned in the direction of the arrows 38, bringing the recesses 24, 26 into engagement with the lips 16 in the final position as shown in FIG. 2. The diaphragm members 22 may be held in this position by adhesive, if desired.

The fitting technique of FIG. 5 also allows diaphragm members to be fitted without prior formation of recesses 24, 26 if the lips 16 are able to cut into the material of the diaphragm members, to form recesses as they are fitted.

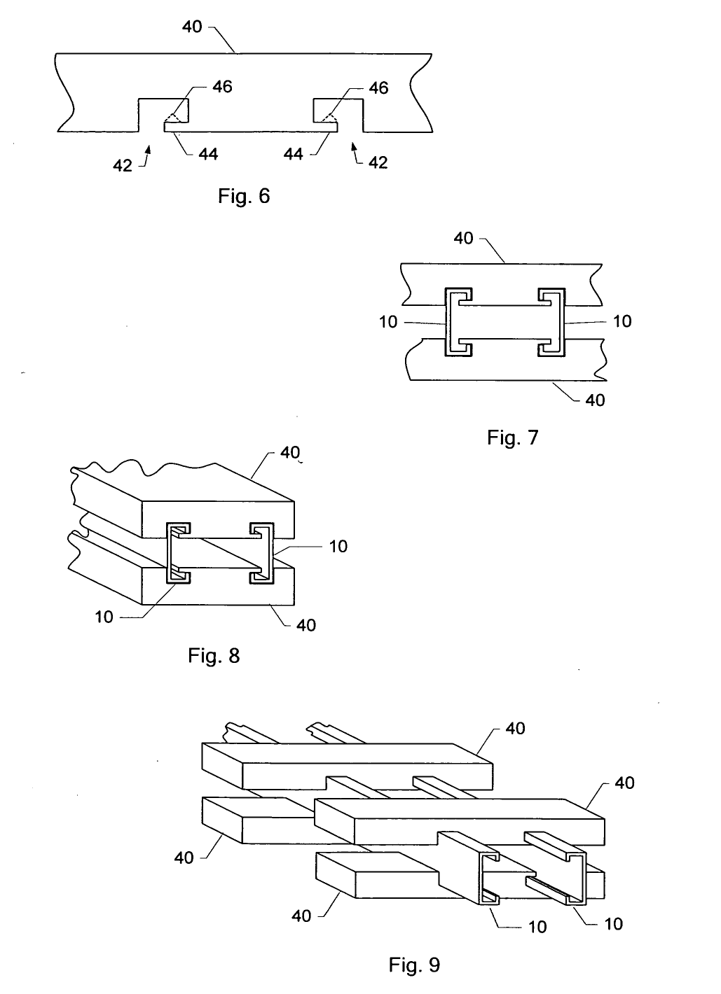

FIG. 6 illustrates part of a profile for a diaphragm member 40 for use in a second embodiment of the invention.

The diaphragm 40 has two channels 42, each partially closed by a lip 44 which is of sufficiently thin material to be deflectable to the position indicated by the broken lines 46.

The shape of the channels 42 is such as to receive the lips 16 of the channel members 10, with a relatively close fit, in order to attach the diaphragm 40 to the channel member 10. This is illustrated in FIG. 7, which shows two diaphragm members 40, arranged with their channels 42 opposing and aligned with each other, and two members 10, each having one edge received in each of the members 40. As can be seen in FIG. 7, the lips 44 help retain the members 10 in the channels 42. Adhesive may also be used to assist in retaining this arrangement.

The result is a beam arrangement in which the diaphragm mechanism is external of the channel members 10.

The diaphragm members 40 may each be formed of a continuous plank of polystyrene foam material extending along substantially the whole length of the channel members 10. This arrangement is illustrated in FIG. 8. Thus, the arrangement of FIG. 8 has external diaphragm arrangements which are continuous along the length of the beam member.

Alternatively, the diaphragm members 40 could be formed as a series of strips of foam material which extend transversely to the channel members 10, as illustrated in FIG. 9. Thus, in this second version of the second embodiment, adjacent diaphragm members 40 are spaced apart along the length of the members 10. In other respects, the form of the members 40, including the manner in which they are installed, is the same in each version of this third embodiment.

In a particularly preferred arrangement of the second version of the third embodiment, the diaphragm members 40 extend beyond the channel members 10 to engage further pairs of channel members from adjacent beam members, so that each beam member is also connected with adjacent beam members.

It is envisaged that in the first embodiment or either version of the second embodiment, the space between diaphragm members, within the boundaries between the channel members, may be filled with an insulating material, such as a foamed concrete or foamed polystyrene material, preferably cast in situ.

Furthermore, it is envisaged that in any of these embodiments, particularly the first embodiment and the first version of the second embodiment, apertures or recesses could be formed in the diaphragm members for receiving services such as electrical wiring, pipe work etc., as shown at 47 (FIGS. 2 and 4). In the second version of the second embodiment, gaps between adjacent diaphragm members allow services to be fed into the central region of the beam member.

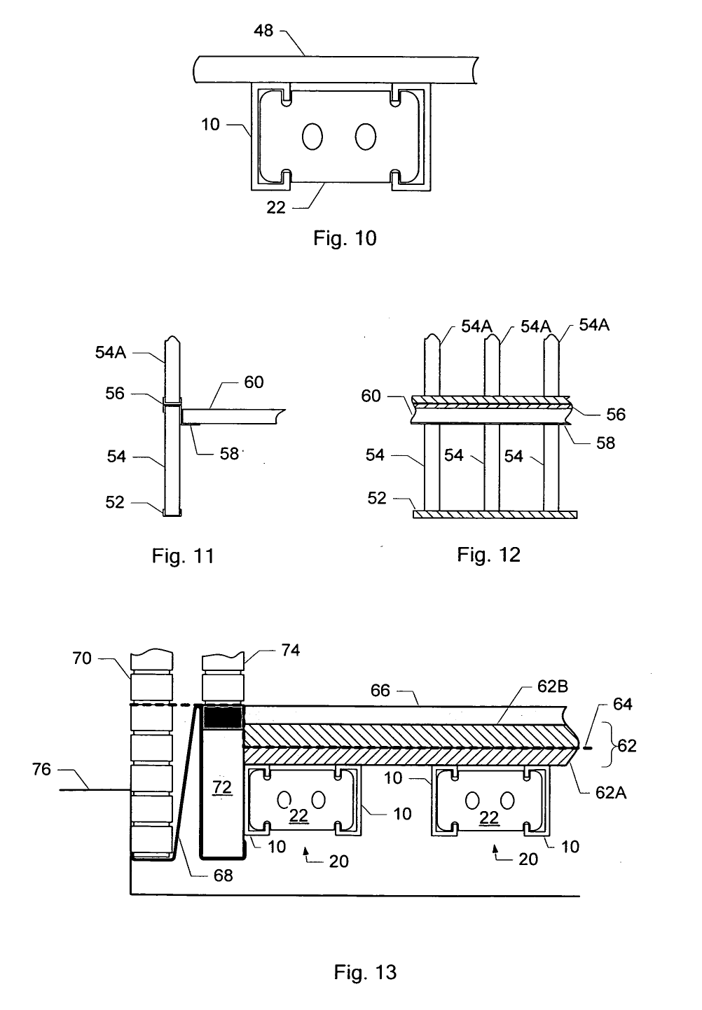

FIG. 10 illustrates an arrangement of the first embodiment of the invention, further including a sheet of board material 48, such as fire retardant sheet, decorative sheet, fiberboard, hardboard, plywood or the like, to form an outer finished surface for the beam member.

FIGS. 11 and 12 illustrate how beam members according to any of the embodiments described above can be used in the formation of a wall structure 50. The wall 50 has a trough 52 at its lower extremity, in which the lower ends of a row of beam members 54 are received. Each of the beam members 54 is in accordance with the present invention and extends generally vertically up from the trough 52. The upper ends of the beam members 54 support a horizontal header 56, which provides various functions. The header is attached to a series of neighbouring beam members 54, preferably at least three, thereby bracing the beam members together. The header 56 can also form a lintel above the space between adjacent beam members 54, for the formation of a door, window or other aperture. The header 56 may also provide support for the bottom end of a further row of beam members 54A, forming a wall of a higher storey of a building being formed. Finally, the header 56 may incorporate a hanger lip 58 for supporting an edge of a floor panel 60 of the upper storey. Alternatively, the hanger lip 58 may support a series of beam members, each formed in accordance with the present invention, providing support for a floor structure for the upper storey.

FIG. 13 shows a floor construction which uses beam members of the type illustrated in FIG. 2. Thus, each beam member 20 has two channel members 10, connected by a series of diaphragm members 22 to provide stiffness and racking resistance to the overall beam arrangement.

The beam members 20 run horizontally, perpendicular to the plane of the view of FIG. 13. They are supported at their ends by appropriate foundation arrangements (not shown). The beam members 20 support, in turn, one or more layers of insulation 62. Preferably, a layer 62A of high density polystyrene is supported directly on the beam members 20, under a second layer 62B of relatively low density polystyrene. These layers 62A, 62B may be separated by a gas impermeable membrane 64, when required in the local building conditions.

A layer of settable material 66, such as a cementitious screed is spread over the insulation layer 62B to complete the floor slab.

In the finished arrangement, the beam members 20 provide structural support to the floor. The screed 66 provides an appropriate finish to the upper surface. The insulation layers 62 provide thermal insulation and in particular, it can be seen that in this arrangement, there are no thermal bridges through the layers 62A, 62B.

The floor construction may be supported around its edges by a foundation arrangement which includes an elongate member 68 of the type described in our co-pending British Patent Application No. GB 2399098. This is an elongate metal member providing support for an outer skin 70 of brickwork, and settable material 72, such as concrete, forming a structural ring around the floor construction, and also supporting an inner skin 74 of brickwork or blockwork. When present, the membrane 64 preferably extends continuously above the settable material 72 and out through the outer skin 70, at a position above ground level 76. The elongate member 68 is set partly below ground level, to achieve a tidy appearance where ground level 76 meets the outer skin 70. The elongate member 68 may be supported by piles, if required (not shown).

Many variations and modifications can be made to the apparatus described above, without departing from the scope of the present invention. In particular, many different shapes and materials may be chosen. The diaphragm members have been described as self-supporting synthetic foam, but other materials could be used. In particular, the diaphragm members could be metal channel members. Dimensions and relative dimensions may be varied in accordance with the application to which the arrangements are intended to be put.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A structural beam member, comprising:
at least two flexible spaced-apart channel members; and
a plurality of spaced-apart diaphragm member coupled to and spanning between the channel members to form a composite load-bearing arrangement.

2. A structural beam member according to claim 1, wherein the diaphragm members comprise self-supporting synthetic foam.

3. A structural beam member according to claim 1, wherein the presence of the diaphragm members provide stiffness to the structural beam member.

4. A structural beam member according to claim 1, wherein the presence of the diaphragm members provide racking resistance to the structural beam member.

5. A structural beam member according to claim 1, wherein each of the plurality of diaphragm members are received within mouths of each of the pair of channel members so as to connect with the channel members.

6. A structural beam member according to claim 5, wherein the mouths have lips formed to engage material of the diaphragm member so as to retain the end of the diaphragm member in the mouth.

7. A structural beam member according to claim 6, wherein the lips cut into the diaphragm material as the beam member is constructed.

8. A structural beam member according to claim 1, wherein the diaphragm member is disposed largely outside a region between the pair of channel members.

9. A structural beam member according to claim 8, wherein the diaphragm member form a substantially continuous diaphragm along the length of the beam member.

10. A structural beam member according to claim 5, wherein the diaphragm member or members have a plurality of recesses to receive the lips.

11. A structural beam member according to claim 10, wherein the plurality of recesses each have at least one nib which initially deflects as the channel member or members are introduced, and return to assist in retaining the channel members in the corresponding recess.

12. A structural beam member according to claim 1, wherein the diaphragms members are spaced apart along a length of the beam

13. A structural beam member according to claim 12, wherein each diaphragm member extends substantially perpendicular to a length of the beam.

14. A structural beam member according to claim 13, wherein at least some of the diaphragm members extend beyond the channel members, in the said perpendicular direction.

15. A structural beam member according to claim 1, wherein at least some of the diaphragm members are provided with apertures for receiving services.

16. A structural beam member according to claim 1, wherein the space between diaphragm members is filled with insulating material.

17. A structural beam member according to claim 16, wherein the insulating material is foamed concrete.

18. A structural beam member according to claim 17, wherein the insulating material is cast in situ.

19. A structural beam member according claim 1, wherein adhesive material is used to connect the channel members and the diaphragm member or members.

20. A structural beam member according to claim 1, further comprising clad disposed on an external surface of the beam member.

21. A building panel comprising a plurality of beam members according to claim 1 are attached together.

22. A building panel according to claim 21, wherein the channel members of neighbouring beam members are attached to form the panel.

23. A building panel according to claim 22, wherein the beam members are attached together adhesively.

24. A building panel according to claim 22, wherein the beam members are attached together by means of one or more diaphragm members extending to engage channel members of more than one beam.

25. A wall arrangement comprising a trough member extending generally horizontally, a plurality of beam members as defined in claim 1, arranged substantially vertically and with their lower ends received in the trough member for support, and a header member extending across the upper ends of the beam members and supported thereby.

26. An wall arrangement as claimed in claim 25, wherein the header member provides a support for a floor panel in the region of the top of the beam member.

27. An wall arrangement according to claim 25, wherein the header member provides support for a second plurality of beam members arranged substantially vertically, above the first plurality.

28. An wall arrangement as claimed in claim 27, wherein the header member provides a support for a floor panel in the region of the top of the beam member.

29. A floor construction comprising a plurality of structural beam members as defined in claim 6, at least one layer of thermal insulation supported by the beam members, and a layer of settable material supported by the thermal insulation.

30. A floor construction according to claim 29, further comprising a plurality of insulation layers.

31. A floor construction according to any of claim 29, wherein the at least one layer of insulation layer is polystyrene.

32. A floor construction comprising a plurality of structural beam members as defined in claim 8, at least one layer of thermal insulation supported by the beam members, and a layer of settable material supported by the thermal insulation.

33. A floor construction according to claim 32, further comprising a gas membrane.

34. A floor construction according to claim 33, wherein the settable material is a cementitious material.

35. A floor construction according to any of claims 34, wherein the settable material is a screed.
